(19) United States
(12) Patent Application Publication
(10) Pub. No.: US 2020/0292688 A1
(43) Pub. Date: Sep. 17, 2020

(54) DETECTION METHOD BY USING A FMCW RADAR

(71) Applicant: Sil Radar Technology Inc., Kaohsiung City (TW)

(72) Inventors: Yi-Ting Tseng, Kaohsiung City (TW); Fu-Kang Wang, Kaohsiung City (TW); Sheng-You Tian, Kaohsiung City (TW)

(21) Appl. No.: 16/508,473

(22) Filed: Jul. 11, 2019

(30) Foreign Application Priority Data
Mar. 15, 2019 (TW) 108109000

(51) Int. Cl. G01S 13/56; G01S 7/35

(52) U.S. Cl. CPC G01S 13/56; G01S 7/352

(57) ABSTRACT

A detection method by using a FMCW radar is disclosed. The FMCW radar divides a detection signal into short-time detection segments and reconfigure the short-time detection segments into detection sub-signals so as to estimate a distance between an object and the FMCW radar according to peak-to-average ratios of the detection sub-signals.

### FIELD OF THE INVENTION

This invention generally relates to a frequency-modulated continuous wave (FMCW) radar, and more particularly to a detection method by using the FMCW radar.

### BACKGROUND OF THE INVENTION

Conventional FMCW radar can be utilized to detect object by transmitting a chirp signal to the object and receiving a reflected signal from the object. The chirp signal transmitted by the FMCW radar changes in frequency over time, thus the reflected signal reflected from the object also changes in frequency over time. The distance between the conventional FMCW radar and the object is estimated depending on the frequency difference between the chirp signal and the reflected signal at the same time. The conventional FMCW radar is employed in detection of distance and migration velocity widely because of small size, precise detection for short distance, and so on.

### SUMMARY

The object of the present invention is to provide a method to detect object having tiny vibrations within a detected area by using a FMCW radar.

A detection method of the present invention includes following steps: obtaining a detection signal by using a FMCW radar, the FMCW radar is configured to transmit a frequency-modulated transmitted signal to an area where an object is located within, and receive a reflected signal as the detection signal from the area; dividing the detection signal into a plurality of short-time detection segments by using a processor, the detection signal is received by the processor from the FMCW radar; analyzing spectrum characteristics of the short-time segments and reconfiguring the short-time detection segments having the same frequency into a plurality of detection sub-signals by using the processor, wherein each of the detection sub-signals corresponds to a detection distance; and calculating peak-to-average ratios of the detection sub-signals by using the processor, wherein the processor is configured to define the detection distance corresponding to one of the detection sub-signals as a distance between the object and the FMCW radar according to the peak-to-average ratios.

In the present invention, the processor is adapted to process the detection signal received by the FMCW radar to obtain the detection sub-signals used to represent vibration levels at each of the detection distances, and calculate the distance between the object and the FMCW radar according to the PAR of each of the detection sub-signals.

### DESCRIPTION OF THE DRAWINGS

FIG. 1 is a flowchart illustrating a detection method by using a FMC V radar in accordance with one embodiment of the present invention.

FIG. 2 is a block diagram illustrating the FMCW radar and a processor in accordance with one embodiment of the present invention.

FIG. 3 is a circuit diagram illustrating the FMCW radar in accordance with one embodiment of the present invention.

FIG. 4 is a diagram illustrating how to divide a detection signal into short-time detection signals and how to reconfigure the short-time detection signals into detection sub-signals in accordance with one embodiment of the present invention.

FIG. 5 is a waveform diagram of a frequency-modulated transmitted signal and a reflected signal in accordance with one embodiment of the present invention.

### DETAILED DESCRIPTION OF THE INVENTION

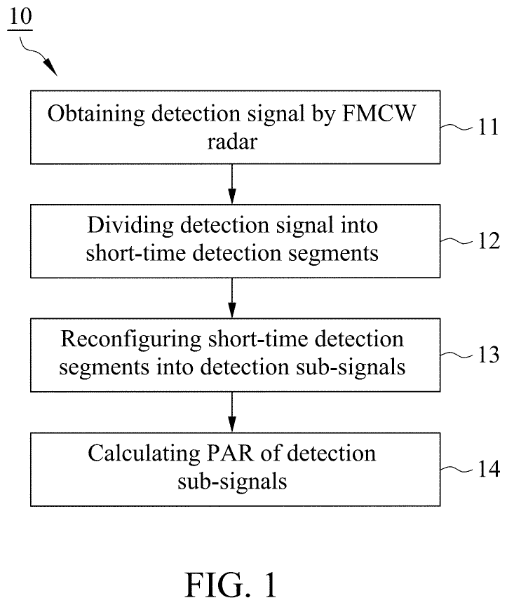

FIG. 1 is a flowchart of a detection method 10 in accordance with one embodiment of the present invention. The detection method 10 includes a step 11 of obtaining detection signal by using FMCW radar, a step 12 of dividing detection signal into short-time detection segments, a step 13 of reconfiguring short-time detection segments into detection sub-signals and a step 14 of calculating PAR of detection sub-signals.

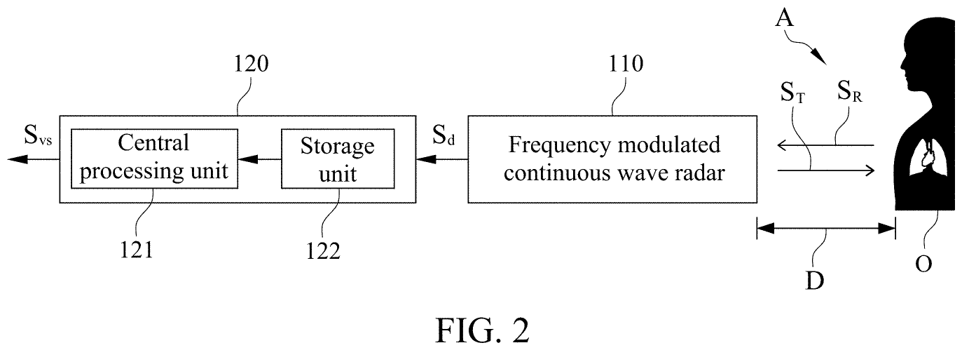

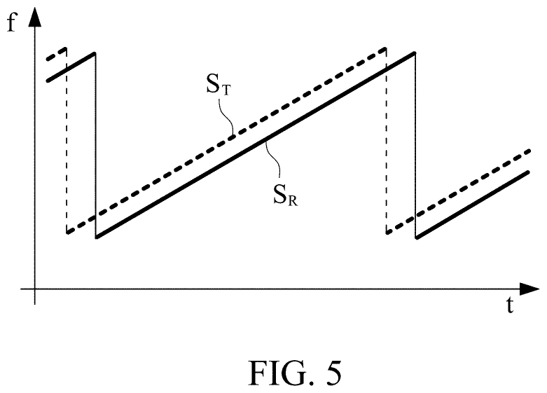

With reference to FIGS. 1 and 2, a FMCW radar 110 in the step 11 is configured to transmit a frequency-modulated transmitted signal S_{T} to an area A, where an object O having tiny vibrations is located within The object O may be a life with vital signs or a machine having fixed vibration frequency. When the frequency-modulated transmitted signal S_{T} is sent to the object O within the area A, the object O reflects a reflected signal S_{R} back to the FMCW radar 110, then the FMCW radar 110 receives the reflected signal S_{R} as a detection signal S_{d}. FIG. 5 represents the frequency variations of the frequency-modulated transmitted signal S_{T} and the reflected signal S_{R} with time. In this embodiment, the frequency-modulated transmitted signal S_{T} has a frequency increased linearly with time during a detection period, so that the reflected signal S_{R} also has a frequency increased linearly with time.

With reference to FIG. 2, the object O has a motion relative to the FMCW radar 110 because of tiny vibrations. The relative movement generates the Doppler Effect in the frequency-modulated transmitted signal S_{T}, thus the reflected signal S_{R} contains the Doppler shift components caused by the relative movement.

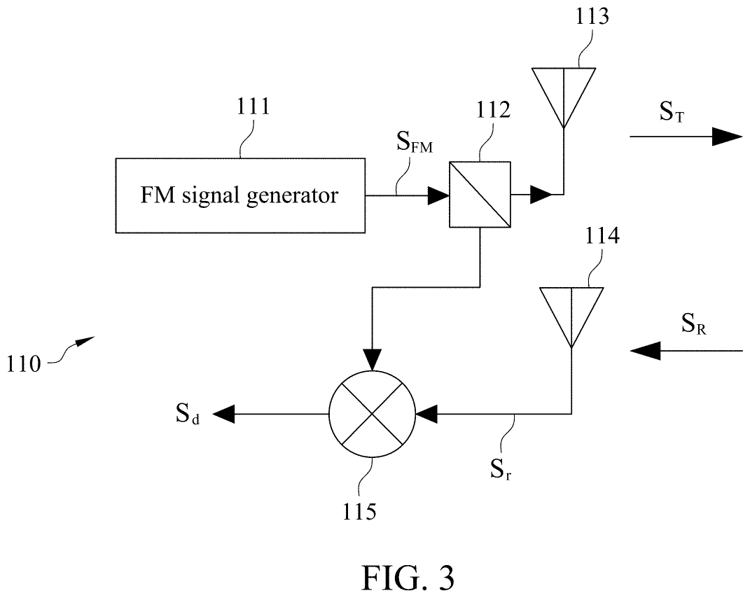

FIG. 3 is a circuit diagram of the FMCW radar 110 of this embodiment. The FMCW radar 110 includes a FM signal generator 111, a power splitter 112, a transmitting antenna 113, a receiving antenna 114 and a mixer 11.5. The FM signal generator 111 is configured to output a frequency-modulated signal S_{FM} having a frequency changed with time. The power splitter 112 is electrically connected to the FM signal generator 111 and configured to divide the frequency-modulated signal S_{FM} into two paths. The power splitter 112 is, but not limited to, a Wilkinson power splitter. The transmitting antenna 113 is electrically connected to the power splitter 112 and configured to receive and transmit the frequency-modulated signal S_{FM} from one path as the frequency-modulated transmitted signal S_{T} to the area A. The receiving antenna 114 is configured to receive the reflected signal S_{R} as a received signal Sᵣ from the object O. The mixer 115 is electrically connected to the power splitter 112 and the receiving antenna 114, thus the mixer 115 can receive the frequency-modulated signal S_{FM} of the other path from the power splitter 112 and receive the received signal Sᵣ from the receiving antenna 114. Further, the mixer 115 is configured to mix the frequency-modulated signal S_{FM} and the received signal Sᵣ to output the detection signal S_{d}. In this embodiment, the frequency of the received signal Sᵣ subtracted from the frequency of the frequency-modulated signal S_{FM} equals the frequency of the detection signal S_{d} from the mixer 115.

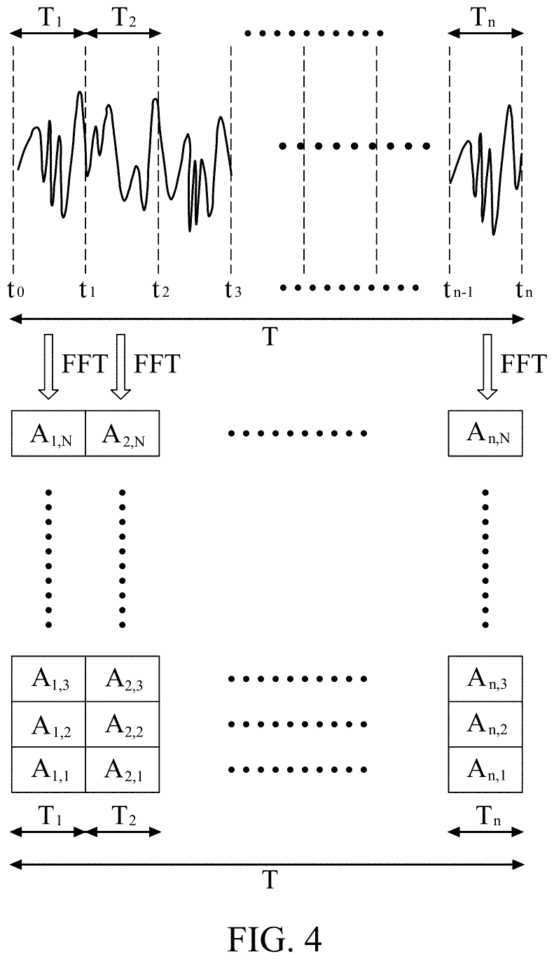

With reference to FIGS. 1 and 2, a processor 120 is configured to receive the detection signal S_{d} from the FMCW radar 110 and partition the detection signal S_{d} into a plurality of short-time detection segments in the step 12. The processor 120 includes a central processing unit 121 and a storage unit 122 in this embodiment. The storage unit 122 is electrically connected to the FMCW radar 110 for receiving and storing the detection signal S_{d}. The central processing unit 121 is electrically connected to the storage unit 122 to receive the detection signal S_{d}. The detection signal S_{d} is partitioned into the short-time detection segments by the central processing unit 121. With reference to FIG. 4, the top one is the detection signal S_{d} and the blocks separated by dotted lines are the short-time detection segments. The durations T₁, T₂. . . and Tₙ of the short-time detection segments are all the same and equal to the frequency periodicity of the frequency-modulated signal S_{FM}.

With reference to FIGS. 1, 2 and 4, the central processing unit 121 of the processor 120 is configured to analyze spectrum characteristics of the short-time detection segments and reconfigure the short-time segments having the same frequency into a plurality of detection sub-signals in the step 13. In this embodiment, the central processing unit 121 is configured to convert the short-time detection segments from time domain to frequency domain using a Fast Fourier Transform (FFT), and then reconfigure the short-time detection segments having the same frequency into one of the detection sub-signals. Consequently, the amplitude variation of the short-time detection segments having the same frequency can be identified in each of the reconfigured detection sub-signals. In the FIG. 4, A_{1,1}, A_{1,N} of the first column represent the amplitude levels of 1^{st} to N^{th} frequencies of the first short-time detection segment, respectively, and in the same way, A_{n,1}, A_{n,2} . . . and A_{n,N} of the N^{th} column represent the amplitude levels of 1^{st} to N^{th} frequencies of the n^{th} short-time detection segment, respectively. Each rows represents one of the detection sub-signals reconfigured from the short-time detection segments having the same frequency. The first row is the first detection sub-signal reconfigured from the segments having the 1^{st} frequency, the second row is the second sub-signal reconfigured from the segments having the 2^{nd} frequency, and so on. Each of the detection sub-signals can be used to identify the amplitude value of the relative movement due to the detection signal S_{d} contains the Doppler shift components caused by the relative movement.

Furthermore, each of the detection sub-signals having a single frequency corresponds to a detection distance due to the relative movement is detected by the FMCW radar 110 in this embodiment and the frequency of the detection signal S_{d} output from the mixer 115 is the difference of the frequency of the frequency-modulated signal S_{FM} with respect to the frequency of the received signal Sᵣ. In this embodiment, the formula of the detection distance calculated from the detection sub-signals is given as follows:

$$R = \frac{{c}_{0} \cdot \vert Δ f \vert}{2 \cdot ( df / dt )}$$

where R is the detection distance corresponding to each of the detection sub-signals, c₀ is the speed of light (3·1.0⁸ m/s), Δf is the frequency of each of the detection sub-signals, (df/dt) is the slope of frequency variation of the frequency-modulated transmitted signal S_{T}.

With reference to FIGS. 1 and 2, in the step 14, the central processing unit 121 of the processor 120 is configured to calculate a peak-to-average ratio (PAR) of each of the detection sub-signals (each rows in FIG. 4), and according to the PAR, define the detection distance corresponding to one of the detection sub-signals as a distance D between the object O and the FMCW radar 110. The higher PAR, the higher amplitude variation of the detection sub-signal, and the amplitude variation of each of the detection sub-signals can be represented as the vibration magnitude of the relative movement, so the PAR of each of the detection sub-signals is directly proportion to the vibration magnitude at the corresponding detection distance. Accordingly, an object O is regarded to be located at the detection distance corresponding to the detection sub-signal having the maximum PAR and has higher vibration intensity. The central processing unit 121 of the processor 120 is configured to define the detection distance which corresponds to the detection sub-signal having the maximum PAR as the distance D from the object O to the FMCW radar 110.

If more than one objects are located within the area A, the central processing unit 121 is configured to estimate the distance D between the each objects O and the FMCW radar 110 based on not only the PAR of each of the detection sub-signals, but also a threshold value. As mentioned previously; the PAR of the detection sub-signal and the vibration magnitude of the object O at the detection distance corresponding to the detection sub-signal are in direct proportion, thus the central processing unit 121 determines the detection distances corresponding to the detection sub-signals having the PAR larger than the threshold value as the distances D of the objects O away from the FMCW radar 110.

With reference to FIG. 1, preferably, the central processing unit 121 of the processor 120 is configured to analyze spectrum characteristics of the detection sub-signal having the maximum PAR to obtain a vital sign signal S_{VS} of the object O in the step 14. The central processing unit 121 preforms a Fast Fourier Transform (HT) on the detection sub-signal to identify the vibration frequency caused by the relative movement so as to further analyze the vital sign of the object O. Additionally, when more than one objects are located within the area A, the processor 120 can analyze spectrum characteristics of the detection sub-signals having the PAR larger than the threshold value to obtain vital sign signals S_{VS} of the objects O.

If the object O is a human, a first frequency range and a second frequency range can be set in the central processing unit 121 of the processor 120 in advance. For example, the first frequency range is between 0.2 Hz and 0.35 Hz that is the frequency range of ordinary human breathing, and the second frequency range, between 1 Hz and 2.5 Hz, is the frequency range of ordinary human heartbeat. Next, the processor 120 set the frequency, within the first frequency range and having a highest amplitude value, of the vital sign signal S_{VS} as a breathing frequency of the object O and set the frequency; within the second frequency range and having a highest amplitude value, of the vital sign signal S_{VS} as a heartbeat frequency of the object O. If the object O is an animal (not human) or a non-living thing having fixed vibration frequency, one or more frequency ranges can be set in the processor 120 according to the possible vibration frequency. The range and the number of the frequency setting in the processor 120 is not limited in the present invention.

The processor 120 of the present invention is utilized to process the detection signal S_{d} detected by the FMCW radar 110 to obtain the detection sub-signals able to represent vibration levels at each of the detection distances, and estimate the distance D from the object O to the FMCW radar 110 by the PAR of each of the detection sub-signals.

The scope of the present invention is only limited by the following claims Any alternation and modification without departing from the scope and spirit of the present invention will become apparent to those skilled in the art.

What is claimed is:

1. A detection method, comprising steps of:
obtaining a detection signal by using a frequency-modulated continuous wave (FMCW) radar, the FMCW radar is configured to transmit a frequency-modulated transmitted signal to an area where an object is located within, and receive a reflected signal as the detection signal from the area;
dividing the detection signal into a plurality of short-time detection segments by using a processor, the detection signal is received by the processor from the FMCW radar;
analyzing spectrum characteristics of the short-time segments and reconfiguring the short-time detection segments having the same frequency into a plurality of detection sub-signals by using the processor, wherein each of the detection sub-signals corresponds to a detection distance; and
calculating peak-to-average ratios of the detection sub-signals by using the processor, wherein the processor is configured to define the detection distance corresponding to one of the detection sub-signals as a distance between the object and the FMCW radar according to the peak-to-average ratios.

2. The detection method in accordance with claim 1, wherein the detection distance corresponded to each of the detection sub-signals is given by the following formula:
$$R = \frac{{c}_{0} \cdot \vert Δ f \vert}{2 \cdot ( df / dt )}$$
where R is the detection distance corresponding to each of the detection sub-signals, c₀ is the speed of light (3·10⁸ m/s), Δf is the frequency of each of the detection sub-signals, (df/dt) is the slope of frequency variation of the frequency-modulated transmitted signal.

3. The detection method in accordance with claim 1, wherein the processor is configured to define the detection distance corresponding to the detection sub-signal having the maximum peak-to-average ratio as the distance between the object and the FMCW radar.

4. The detection method in accordance with claim 3, wherein the processor is configured to analyze spectrum characteristics of the detection sub-signal having the maximum peak-to-average ratio to obtain a vital sign signal.

5. The detection method in accordance with claim 1 further comprising a step of analyzing spectrum characteristics of the detection sub-signals by using the processor to obtain a plurality of vital sign signals.

6. The detection method in accordance with claim 4 further comprising a step of setting a frequency range and defining a frequency, within the frequency range and having a highest amplitude value, of the vital sign signal as a vital vibration frequency of the object.

7. The detection method in accordance with claim 5 further comprising a step of setting a frequency range and defining a frequency, within the frequency range and having a highest amplitude value, of the vital sign signal as a vital vibration frequency of the object.

8. The detection method in accordance with claim 1, wherein the processor includes a central processing unit and a storage unit, the storage unit is electrically connected to the FMCW radar and configured to receive and store the detection signal, the central processing unit is electrically connected to the storage unit and configured to receive and process the detection signal.

9. The detection method in accordance with claim 1, wherein the FMCW radar includes a FM signal generator, a power splitter, a transmitting antenna, a receiving antenna and a mixer, the FM signal generator is configured to output a frequency-modulated signal, the power splitter is electrically connected to the FM signal generator and configured to divide the frequency-modulated signal into two paths, the transmitting antenna is electrically connected to the power splitter and configured to receive and transmit the frequency-modulated signal from one path as the frequency-modulated transmitted signal, the receiving antenna is configured to receive the reflected signal as a received signal, the mixer is electrically connected to the power splitter and the receiving antenna and configured to receive the frequency-modulated signal from the other path and the received signal, and the mixer is further configured to mix the frequency-modulated signal and the received signal to output the detection signal.
